(19) United States
(12) Patent Application Publication
(10) Pub. No.: US 2004/0243427 A1
(43) Pub. Date: Dec. 2, 2004

(54) Business operation smoothing system, business operation smoothing method, and program product

(76) Inventor: Toyoji Ikezawa, Kanagawa (JP)

Correspondence Address: MORRISON & FOERSTER LLP, 1650 TYSONS BOULEVARD, SUITE 300, MCLEAN, VA, 22102, US

(21) Appl. No.: 10/845,529

(22) Filed: May 14, 2004

(30) Foreign Application Priority Data
May 14, 2003 (JP) 2003-135845

(51) Int. Cl. G06F 17/60

(52) U.S. Cl. 705/1

(57) ABSTRACT

A sales assistance server apparatus includes an activity information obtaining section, an activity information storing section and a start information transmitting section. A kitting management server apparatus, a business operation server apparatus and/or a service assistance server apparatus are connected to the sales assistance server apparatus via a network. The activity information obtaining section obtains sales activity information according to a user input operation, the activity information storing section stores the sales activity information in a sales activity information DB and records the information therein. The start information transmitting section transmits kitting operation start information of goods as a kitting object to the kitting management server apparatus based on the stored sales activity information. The kitting management server apparatus records information indicating that the kitting operation of goods relating to the kitting operation start information is executable based on the transmitted kitting operation start information.

### BACKGROUND OF THE INVENTION

1. Field of the Invention

The present invention relates to a business operation smoothing system, business operation smoothing method, and program product that smoothes business operation processing.

1. Description of the Related Art

Conventionally, in order to assist sales activities for salespersons, an SFA (Sales Force Assistance) is used. The SFA system is a system that stores, analyzes or browses sales activity information indicating the contents of the sales activity for a salesperson in order to grasp the repetition of process, which includes a sales plan, an order activity, sales of goods, an activity after selling, a relationship construction, a product review and the like as a sales activity and to assist the sales activity for a salesperson. Accordingly, sales results and the like obtained by the salespersons are input to the SFA system to use them for future sales activities in the company to which the salespersons belong.

In many cases, the salespersons settle business negotiations at the end of the term such as end of the month and the like in order to achieve a sales target for each month. For this reason, business operation, client service, delivery of goods, and the like that are carried out after settling the business negotiation are concentrated at the end of the term.

Though the salespersons input the sales results in the SFA system, because the business operations or working carried out after settling the business negotiation are not clarified to the business department, service department and the like in advance, these business operations and the like are concentrated at the end of the term, which leads to reducing the efficiency of business operations. One of the causes of this problem is that the number of man-hours and the date relating to the sales processing operation, goods ordering operation, delivery working and the like are not notified to the above departments until the business negotiation is settled, resulting in difficulty of making a business schedule.

In the company dealing with goods (including service) that need the kitting and customer support of the product, for example, office automation equipment such as a personal computer, a copy machine, a printer and the like, they have many business operations or working to be carried out after settling the business negotiation and can not avoid the reduction in efficiency to cause, particularly, a problem that these business operations and the like are concentrated at the end of the term.

The present invention has been made with consideration given to the aforementioned circumstances, and an object of the present invention is to provide a business operation smoothing system, business operation smoothing method and program product that avoid variations in time to make it possible to smooth business operations and working such as processing operations (sales processing, goods order, etc), client support, kitting operation, delivery working and the like that are caused as a result of a sales activity and carried out by an operation department.

### SUMMARY OF THE INVENTION

In order to attain the above object, a business operation smoothing system according to a first aspect of the present invention is a business operation smoothing system including a sales assistance server apparatus that performs sales assistance for a salesperson of goods. The business operation smoothing system further includes a kitting management server apparatus that is connected to the sales assistance server apparatus via a network to manage a kitting operation at a kitting center that executes kitting of goods. The assistance server apparatus includes an activity information obtaining section that obtains sales activity information input according to a user operation. The assistance server apparatus further includes an activity information storing section that stores the sales activity information obtained by the activity information obtaining section. The assistance server apparatus further includes a start information transmitting section that transmits kitting operation start information for starting the kitting operation to the kitting management server apparatus based on the sales activity information stored in the activity information storing section.

According to this configuration, since the start information for starting the kitting operation is transmitted to the kitting management server apparatus based on the sales activity information stored by the sales assistance server apparatus, a kitting operator can browse the start information by the kitting management server apparatus. This makes it possible to smooth the operation and increase efficiency.

The business operation smoothing system may further include a service assistance server apparatus that is connected to the sales assistance server apparatus via the network to assist client service at the client service center. The start information transmitting section may further include a section that transmits client service start information for starting to provide client service to the service assistance server apparatus based on the sales activity information stored in the activity information storing section.

The information for starting processing of goods relating to the sales activity information is transmitted to the service assistance server apparatus and the kitting management server apparatus based on the sales activity information stored by the sales assistance server apparatus. Accordingly, a client service provider and the kitting operator can browse the client service start information and the kitting operation start information by the service assistance server apparatus and the kitting management server apparatus, respectively. This makes it possible to smooth and increase efficiency.

The service assistance server apparatus may further include a report transferring section that is connected to a client service adapter connected to client equipment via a network to transfer a report as sales activity information from the client service adapter and information transmitted according to the report to the sales assistance server apparatus.

The information from the client is stored as sales activity information by the sales assistance server apparatus, and the client service start information for starting to provide client service to the client relating to the information and the kitting operation start information for starting the kitting operation are transmitted to the service assistance server apparatus and the kitting management server apparatus, respectively. Accordingly, the client service provider and the kitting operator can browse the client service start information and the kitting operation start information by the service assistance server apparatus and the kitting management server apparatus, respectively. This makes it possible to smooth and increase efficiency.

The business operation smoothing system may further include a business operation server apparatus that is connected to the sales assistance server apparatus via the network to manage a business operation of a company to which the salesperson belongs. The start information transmitting section may further include a section that transmits business operation start information for starting business operation processing to the business operation server apparatus based on the sales activity information stored in the activity information storing section.

The business operation start information for starting business operation processing and the kitting operation start information for starting the kitting operation are transmitted to the business operation server apparatus and the kitting management server apparatus, respectively. Accordingly, a business operation processor and the kitting operator can browse the business operation start information and the kitting operation start information by the business operation server apparatus and the kitting management server apparatus, respectively. This makes it possible to smooth and increase efficiency.

In order to attain the aforementioned object, a business operation smoothing system according to a second embodiment of the present invention is a business operation smoothing system including a sales assistance server apparatus that performs sales assistance for a salesperson of goods. The business operation smoothing system further includes a service assistance server apparatus that is connected to the sales assistance server apparatus via a network to assist client service at a client service center.

The assistance server apparatus includes an activity information obtaining section that obtains sales activity information input according to a user operation. The assistance server apparatus further includes an activity information storing section that stores the sales activity information obtained by the activity information obtaining section. The assistance server apparatus further includes a start information transmitting section that transmits client service start information for starting to provide client service to the service assistance server apparatus based on the sales activity information stored in the activity information storing section.

In order to attain the aforementioned object, a business operation smoothing system according to a third aspect of the present invention is a business operation smoothing system including a sales assistance server apparatus that performs sales assistance for a salesperson of goods. The business operation smoothing system further includes a business operation server apparatus that manages a business operation of a company to which the salesperson belongs.

The sales assistance server apparatus includes an activity information obtaining section that obtains sales activity information input according to a user operation. The sales assistance server apparatus further includes an activity information storing section that stores the sales activity information obtained by the activity information obtaining section. The sales assistance server apparatus further includes a start information transmitting section that transmits business operation start information for starting business operation processing to the business operation server apparatus based on the sales activity information stored in the activity information storing section.

In order to attain the aforementioned object, a business operation smoothing method according to a fourth aspect of the present invention using a sales assistance server apparatus that performs sales assistance for a salesperson of goods. The business operation smoothing method further uses a kitting management server apparatus that is connected to the sales assistance server apparatus via a network to manage a kitting operation at a kitting center that executes kitting of goods.

The business operation smoothing method includes the activity information obtaining step of causing the sales assistance server apparatus to obtain sales activity information input according to a user operation. The business operation smoothing method further includes the activity information storing step of storing sales activity information of the salesperson obtained by the activity information obtaining step in the sales assistance server apparatus. The business operation smoothing method further includes the start information transmitting step of causing the sales assistance server apparatus to transmit kitting operation start information of the goods as a kitting object to the kitting management server apparatus based on the sales activity information stored by the activity information storing step.

According to this method, since the kitting start information for starting the kitting operation of the goods relating to the sales activity information is transmitted to the kitting management server apparatus, a kitting operator can obtain the kitting operation start information from the kitting management server apparatus. This makes it possible to smooth and increase efficiency.

In order to attain the aforementioned object, a business operation smoothing method according to a fifth aspect of the present invention uses a sales assistance server apparatus that performs sales assistance for a salesperson of goods. The business operation smoothing method further uses a service assistance server apparatus that is connected to the sales assistance server apparatus via a network to assist client service at a client service center.

The business operation smoothing method includes the activity information obtaining step of causing the sales assistance server apparatus to obtain sales activity information input according to a user operation. The business operation smoothing method further includes the activity information storing step of storing sales activity information of the salesperson obtained by the activity information obtaining step in the sales assistance server apparatus. The business operation smoothing method further includes the start information transmitting step of causing the sales assistance server apparatus to transmit client service start information of the client of the goods relating to the sales activity information to the service assistance server apparatus based on the sales activity information stored by the activity information storing step.

According to this method, since the client service start information for starting to provide client service to the client relating to the sales activity information is transmitted to the service assistance server apparatus, a client service provider can obtain the client service start information from the service assistance server apparatus. This makes it possible to smooth and increase efficiency.

In order to attain the aforementioned object, a business operation smoothing method according to a sixth aspect of the present invention uses a sales assistance server apparatus that performs sales assistance for a salesperson of goods. The business operation smoothing method further uses a business operation server apparatus that is connected to the sales assistance server apparatus via a network to manage a business operation of a company to which the salesperson belongs.

The business operation smoothing method includes the activity information obtaining step of causing the sales assistance server apparatus to obtain sales activity information input according to a user operation. The business operation smoothing method further includes the activity information storing step of storing sales activity information of the salesperson obtained by the activity information obtaining step in the sales assistance server apparatus. The business operation smoothing method further includes the start information transmitting step of causing the sales assistance server apparatus to transmit business operation start information of a processing business operation of the goods relating to the sales activity information to the business operation server apparatus based on the sales activity information stored by the activity information storing step.

According to this method, since the business operation start information for starting the business operation of the goods relating to the sales activity information is transmitted to the business operation server apparatus, a business operation processor can obtain the business operation start information from the business operation server apparatus. This makes it possible to smooth and increase efficiency.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating a configuration example of a business operation smoothing system according to a first embodiment of the present invention;

FIG. 2 is a block diagram illustrating a configuration example of a server apparatus that forms the business operation smoothing system of the embodiment of the present invention;

FIG. 3 is a flowchart explaining business operation smoothing processing of the business operation smoothing system of FIG. 1;

FIG. 4 is a block diagram illustrating a configuration example of a business operation smoothing system according to a second embodiment of the present invention;

FIG. 5 is a flowchart explaining business operation smoothing processing of the business operation smoothing system of FIG. 4

FIG. 6 is a block diagram illustrating a configuration example of a business operation smoothing system according to a third embodiment of the present invention;

FIG. 7 is a flowchart explaining business operation smoothing processing of the business operation smoothing system of FIG. 6;

FIG. 8 is a block diagram illustrating a configuration example of a business operation smoothing system according to a fourth embodiment of the present invention; and

FIG. 9 is a flowchart explaining business operation smoothing processing of the business operation smoothing system of FIG. 8.

### DETAILED DESCRIPTION OF THE PREFERRED EMBODIMENTS

(First Embodiment)

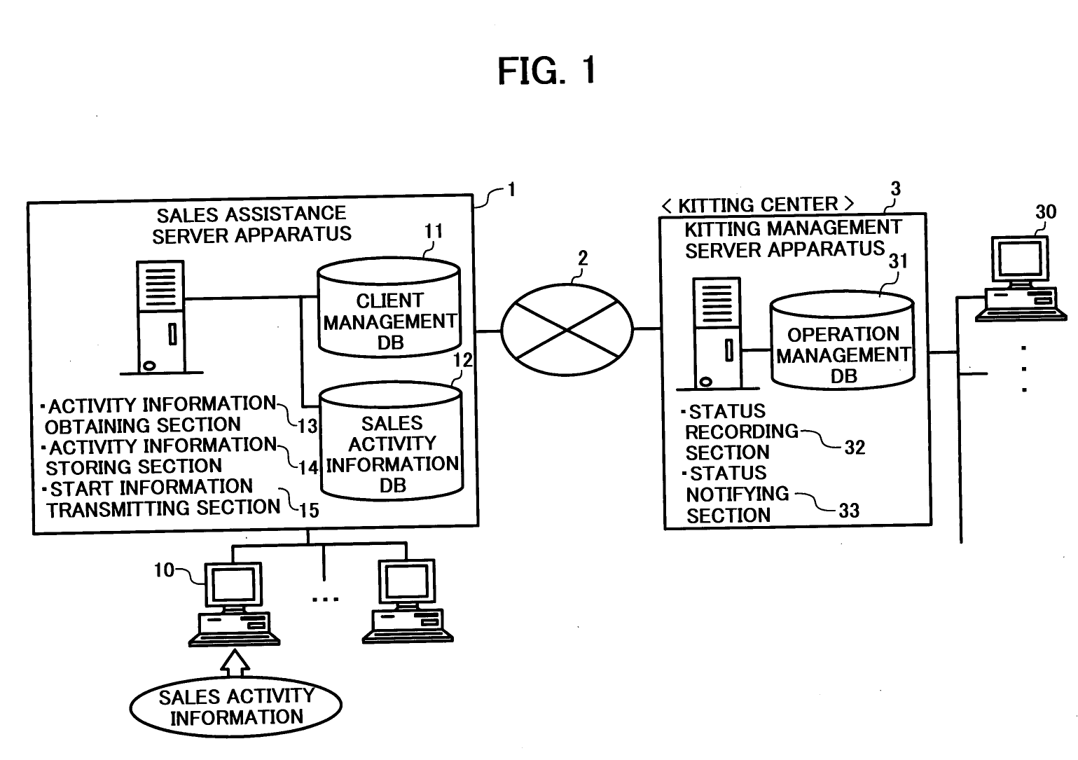

FIG. 1 is a block diagram illustrating a configuration example of a business operation smoothing system according to a first embodiment of the present invention. With reference to FIG. 1, the business operation smoothing system includes a sales assistance server apparatus 1 and a kitting management server apparatus 3. The sales assistance server apparatus 1 and the kitting management server apparatus 3 are connected to each other via a network 2.

Herein, the network 2 is configured as a network system that includes an internet, an intranet, an extranet and the like using a communications channel (wire or wireless). The network system is constructed based on a LAN (Local Area Network).

The sales assistance server apparatus 1 includes a client management database 1, a sales activity information database 12, an activity information obtaining section 13, an activity information storing section 14, and a start information transmitting section 15.

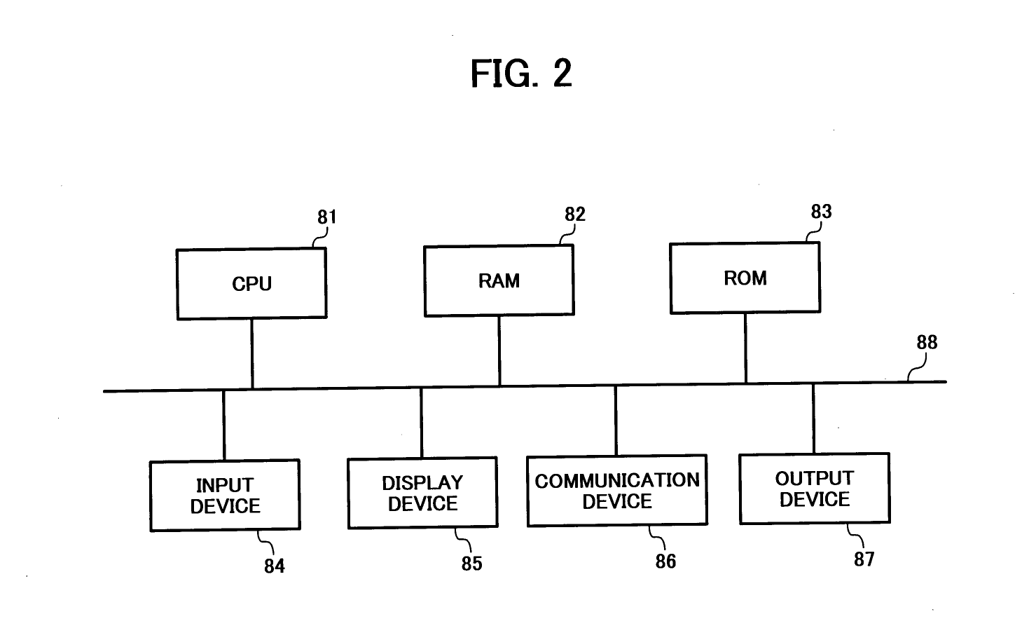

FIG. 2 is a block diagram illustrating a configuration example of the sales assistance server apparatus 1. As illustrated in the figure, the sales assistance server apparatus 1 includes a CPU 81, a RAM 82, a ROM 83, an input device 84, a display device 85, a communications device 86, and an output device 87.

The CPU 81, ROM 82, and RAM 83 form a control section.

The CPU 81 is a microcomputer apparatus.

The RAM 82 temporarily stores information.

The ROM 83 stores information to be used in the present system. The ROM 83 further stores a program for causing the computer to function as a system of the present invention.

The input device 84 includes pointing devices such as a keyboard, a mouse and the like.

The display device 85 includes a CRT or LCD.

The communications device 86 is equipment that is connected to the network 2 to perform communications.

The output device 87 is an output control device that outputs a processing result and the like executed by the control section to the display device.

The CPU 81, RAM 82, ROM 83, input device 84, display device 85, communications device 86, and the output device 87 are connected to one another by a bus 88.

The CPU 81 suitably reads information stored in the ROM 83 and corrects the read information. The CPU 81 executes processing according to a parameter designated by the input device 85. The CPU 81 displays an intermediate result of processing and a processing result on the display device 85. The CPU 81 executes a program stored in the ROM 83 to provide the corresponding graphical user interference (GUI) to the display device 85.

A terminal device 10 is a personal computer apparatus that is connected to the sales assistance server apparatus 1.

Client information of the sold goods is recorded in the client management database 11.

Salesperson activity information input for each stage of the negotiation is recorded in the sales activity information database 12. The sales activity information includes information of a success rate in each stage of the sales activity of the salesperson. Herein, the information of the success rate of the goods in each stage of the sales activity is, for example, information indicating the success rate to be predicted according to the degree of advancement of the sales activity relating to the goods.

In addition, the sales activity information database 12 is configured to be accessible from the kitting management server apparatus 3 via the network 2.

The activity information obtaining section 13 is an input interference device. The activity information obtaining section 13 receives salesperson sales activity information input from the terminal device 10, and performs conversion to a suitable format and transmits the result to the activity information storing section 14.

The activity information storing section 14 stores the sales activity information received from the activity information obtaining section 13 in the sales activity information database and records the sales activity information therein.

The start information transmitting section 15 transmits kitting operation start information of goods as a kitting object relating to the sales activity information to the kitting management server apparatus 3 based on the sales activity information stored by the activity information storing section 14.

The start information transmitting section 15 includes a predictive sales number calculating section (not shown). The predictive sales number calculating section gains access to the sales activity information database 12 to obtain information of the success rate of the goods as the kitting object, and calculates the predictive number of selling goods and a predictive sales date of the goods based on information of the obtained success rate. The start information transmitting section 15 transmits the predictive number of selling goods and the predictive sales date calculated by the predictive sales number calculating section to the kitting management server apparatus 3 at the moment when a flag, which shows a status of a matter relating to the sales activity information, is set to, for example, an order status.

The kitting management server apparatus 3 includes a business operation management database 31, a status recording section 32, a status notifying section 33, and a schedule calculating section.

The kitting management server apparatus 3 is a server apparatus that manages the kitting operation at a kitting center (that is provided at multiple locations in some cases) where the goods are kitted. Moreover, since the kitting management server apparatus 3 has the same configuration as that of the sales assistance server apparatus 1 illustrated in FIG. 2, the explanation of the configuration is omitted.

A terminal device 30 is a personal computer apparatus that is connected to the kitting management server apparatus 3.

Information of the kitting operation is recorded in the business operation management database 31.

When the kitting operation of goods relating to kitting operation start information is executable at the kitting center based on the kitting operation start information transmitted by the start information transmitting section 15 of the sales assistance server apparatus 1, the status recording section 32 records information, which indicates that the kitting operation is executable, in the business operation management database 31

The status notifying section 33 notifies the terminal apparatus 30 of the kitting operator of information that is recorded by the status recording section 32 and indicates an executable status. The kitting operator can browse kitting operation start information and start the kitting operation based on the notified information.

The schedule calculating section calculates a schedule including a personnel assignment and a time schedule in connection with the kitting operation such as machine setting and the like based on the kitting operation start information received from the sales assistance server apparatus 1. It is assumed that the schedule calculating section calculates a kitting operation schedule including a plan for receiving assembling parts and the like.

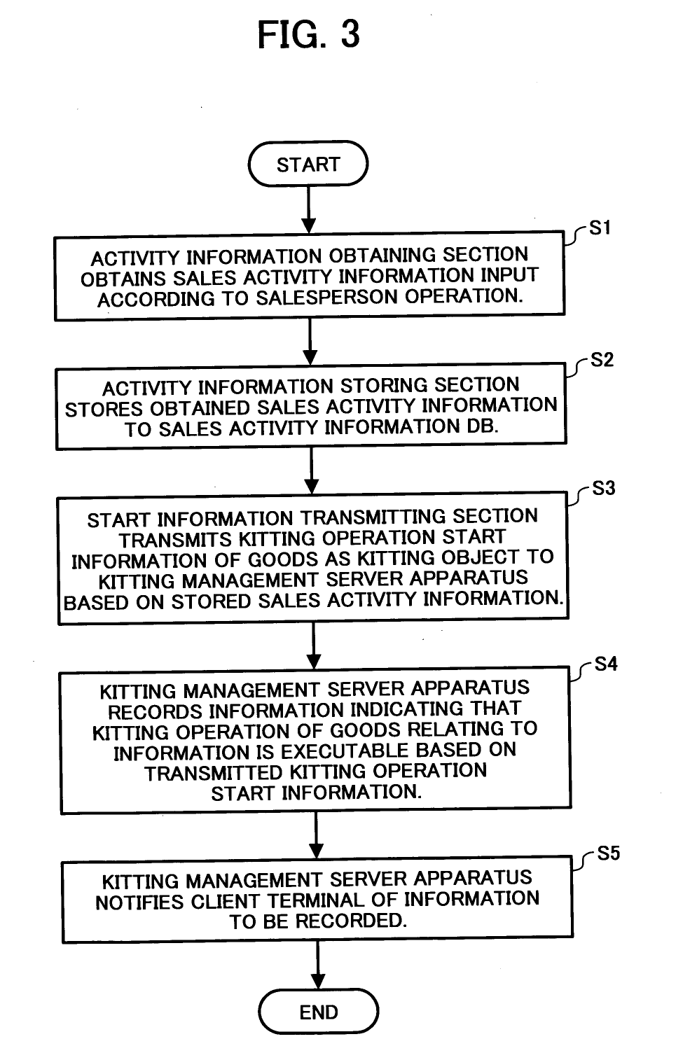

An explanation is given of business operation smoothing processing of the business operation smoothing system illustrated in FIG. 1 with reference to FIG. 3.

The activity information obtaining section 13 of the sales assistance server apparatus 1 obtains sales activity information input from the terminal device 10 according to the salesperson operation (step S1), and transmits the sales activity information to the activity information storing section 14. The activity information storing section 14 stores the received sales activity information to the sales activity information database 12 and records the sales activity information therein (step S2). The start information transmitting section 15 transmits kitting operation start information of the goods as a kitting object to the kitting management server apparatus 3 based on the sales activity information stored by the activity information storing section 14 (step S3). Then, the status recording section 32 of the kitting management server apparatus 3 records information, which indicates that the kitting operation of the goods relating to the kitting start information is executable, in the business operation management database 31 based on the transmitted kitting start information (step S4). The status notifying section 33 notifies the terminal apparatus 30 of information that is recorded by the status recording section 32 and indicates an executable status (step S5).

As explained above, according to the present embodiment, it is possible to avoid variations in time and smooth the operations such as kitting, delivery and the like that are caused as a result of the sales activity, and improve efficiency of these operations. Moreover, since the kitting management server apparatus 3 is configured to be accessible to sales activity information stored by the sales assistance sever apparatus 1, not only the salesperson but also the kitting operator share sales activity information. Accordingly, read time of sales activity information to the kitting operator is reduced, so that operation efficiency can be improved.

Though the first embodiment has explained that the network 2 is constructed based on LAN, this may be constructed by WAN (Wide Area Network) or MAN (Metropolitan Area Network) according to the installing locations of the sales assistance server apparatus and kitting management server apparatus. Moreover, regarding the network 2, it is desirable that security be strengthened by the use of a dedicated line, encryption of transmission data, authentication of each user who uses each terminal device and the like. Particularly, as in the aforementioned embodiment, it is necessary to strengthen security when the Internet connection is used. In addition, the use of the network system, which is formed by only the Internet technique, is preferably limited to communication from an adopter connected to a client product to be described later.

(Second Embodiment)

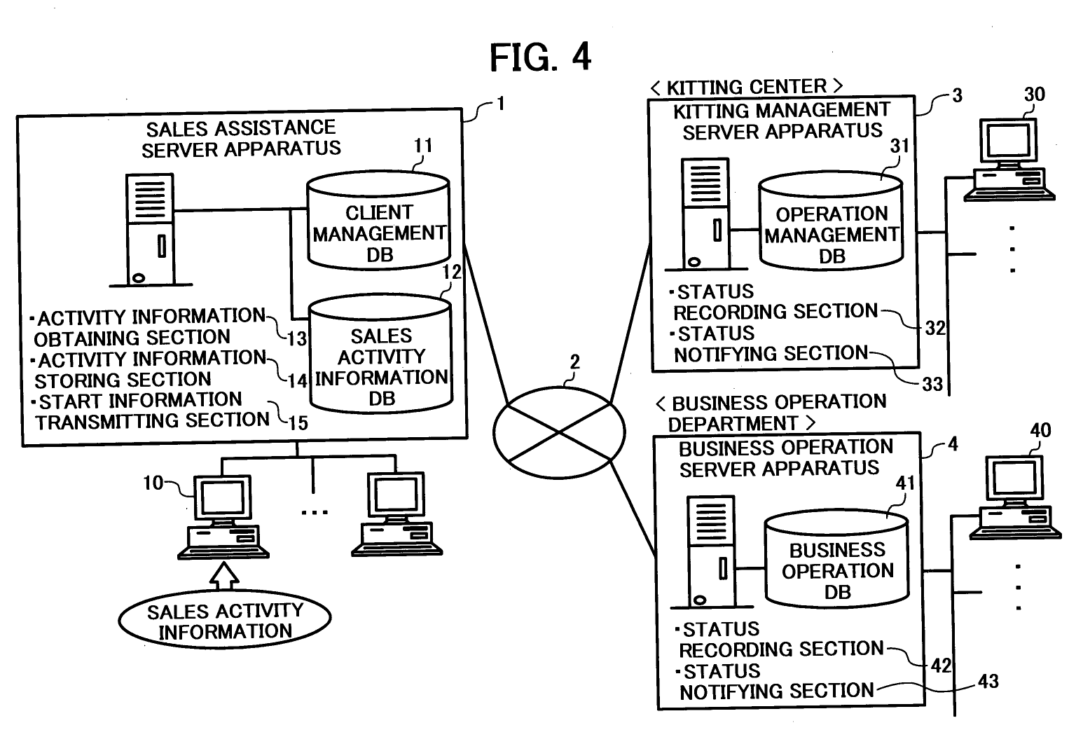

FIG. 4 illustrates one configuration example of a business operation smoothing system according to a second embodiment of the present invention. With reference to FIG. 4, the business operation smoothing system includes the sales assistance server apparatus 1, the kitting management server apparatus 3, and a business operation server apparatus 4. Since the sales assistance server apparatus 1 and the kitting management server apparatus 3 have the same configuration as that of the business operation smoothing system of FIG. 1, the same reference numerals as those of FIG. 1 are added to the parts corresponding to FIG. 1 and the explanation is omitted.

Herein, the start information transmitting section 15 of the sales assistance server apparatus 1 transmits kitting operation start information of the sales activity information to the kitting management server apparatus 3 and transmits business operation start information of contracted goods to the business operation server apparatus 4 based on sales activity information stored by the activity information storing section 14. Moreover, the start information transmitting section 15 transmits the predictive number of sales and the predictive sales date calculated by the predictive sales number calculating section to the kitting management server apparatus 3 and the business operation server apparatus 4 at the moment when a flag, which shows a status of a matter relating to the sales activity information, is set to, for example, an order status.

In addition, the sales activity information database 12 of the sales assistance server apparatus 1 is configured to be accessible from the kitting management server apparatus 3 and the business operation server apparatus 4 via the network (the same network as the network 2 may be possible).

The business operation server apparatus 4 includes a business operation management database 41, a status recording section 42, and a status notifying section 43. The business operation server apparatus 4 is a server apparatus that manages the business operations of the company to which the salespersons belong. Moreover, since the business operation server apparatus 4 has the same configuration as that of the sales assistance server apparatus 1 shown in FIG. 2, the explanation of the configuration is omitted.

A terminal device 40 is a personal computer apparatus that is connected to the business operation server apparatus 4 via the network.

Information of processing business operations is recorded in the business operation management database 41.

When processing business operations such as order processing, delivery processing, sales processing and the like of the goods relating to the business operation start information are executable at the business operation department, the status recording section 42 records information, which indicates that any one of these business operations or multiple business operations is executable, in the business operation management database 41 based on business operation start information transmitted by the start information transmitting section 15 of the sales assistance server apparatus 1.

The status notifying section 43 notifies the terminal apparatus 40 of a business operation processor of information that is recorded by the status recording section 42 and indicates an executable status. The business operation processor can browse business operation start information and start the business operations based on the notified information.

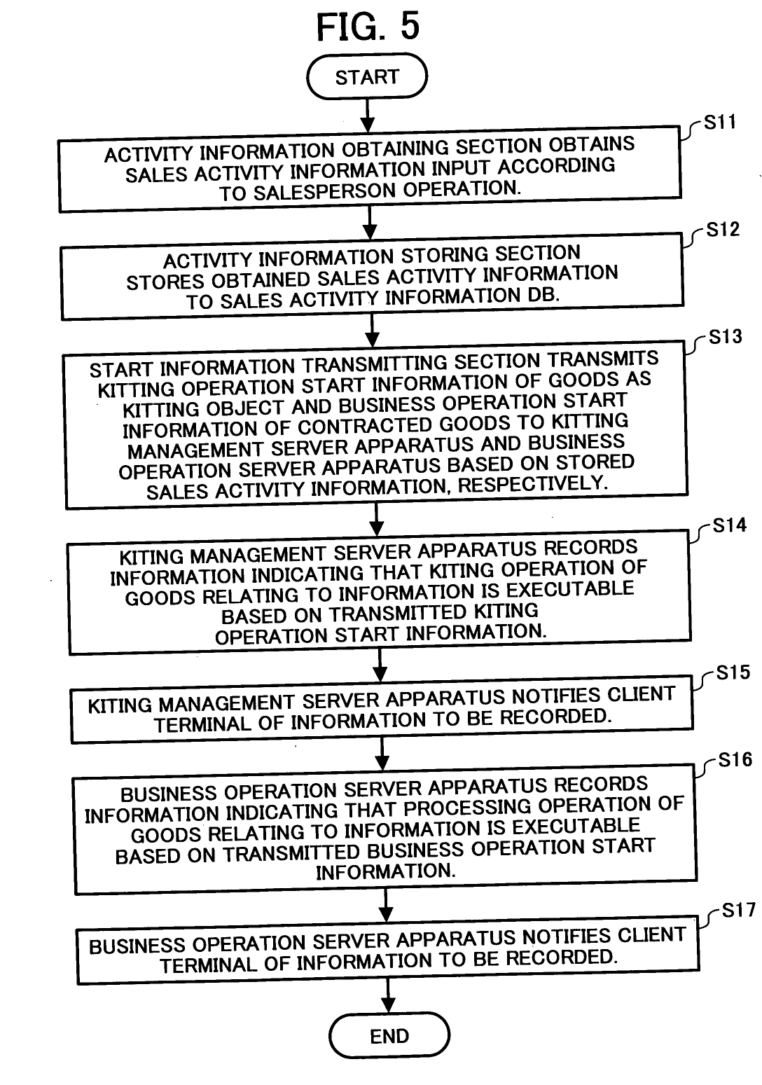

An explanation is given of business operation smoothing processing of the business operation smoothing system illustrated in FIG. 4 with reference to FIG. 5.

The activity information obtaining section 13 of the sales assistance server apparatus 1 obtains sales activity information input from the terminal device 10 according to the salesperson operation (step S11), and transmits the sales activity information to the activity information storing section 14. The activity information storing section 14 stores the received sales activity information to the sales activity information database 12 and records the sales activity information therein (step S12). The start information transmitting section 15 transmits kitting operation start information of the goods as a kitting object and business operation start information of the contracted goods to the kitting management server apparatus 3 and the business operation apparatus 4, respectively based on the sales activity information stored by the activity information storing section 14 (step S13). Then, the status recording section 32 of the kitting management server apparatus 3 records information, which indicates the kitting operation of the goods relating to the kitting start information is executable, in the business operation management database 31 based on the transmitted kitting start information (step S14). The status notifying section 33 of the kitting management server apparatus 3 notifies the terminal apparatus 30 of information that is recorded by the status recording section 32 and indicates an executable status (step S15). Moreover, the status recording section 42 of the business operation server apparatus 4 records information, which indicates that the processing business operation of the goods relating to the business operation start information is executable, in the business operation management database 41 based on the transmitted business operation start information (step S16). The status notifying section 43 of the business operation server apparatus 4 notifies the terminal apparatus 40 of information that is recorded by the status recording section 42 and indicates an executable status (step S17).

As explained above, according to the embodiment of the present invention, it is possible to avoid variations in time and smooth the processing business operations and working such as kitting, delivery and the like, which are caused as a result of the sales activity, and improve efficiency of these operations or working. Moreover, since the business operation server apparatus 4 and the kitting management server apparatus 3 are configured to be accessible to the sales activity information database 12, not only the sale person but also the business operation processor and the kitting operator share sales activity information. Accordingly, read time of sales activity information to the business operation processor and the kitting operator is reduced, so that operation efficiency can be improved.

(Third Embodiment)

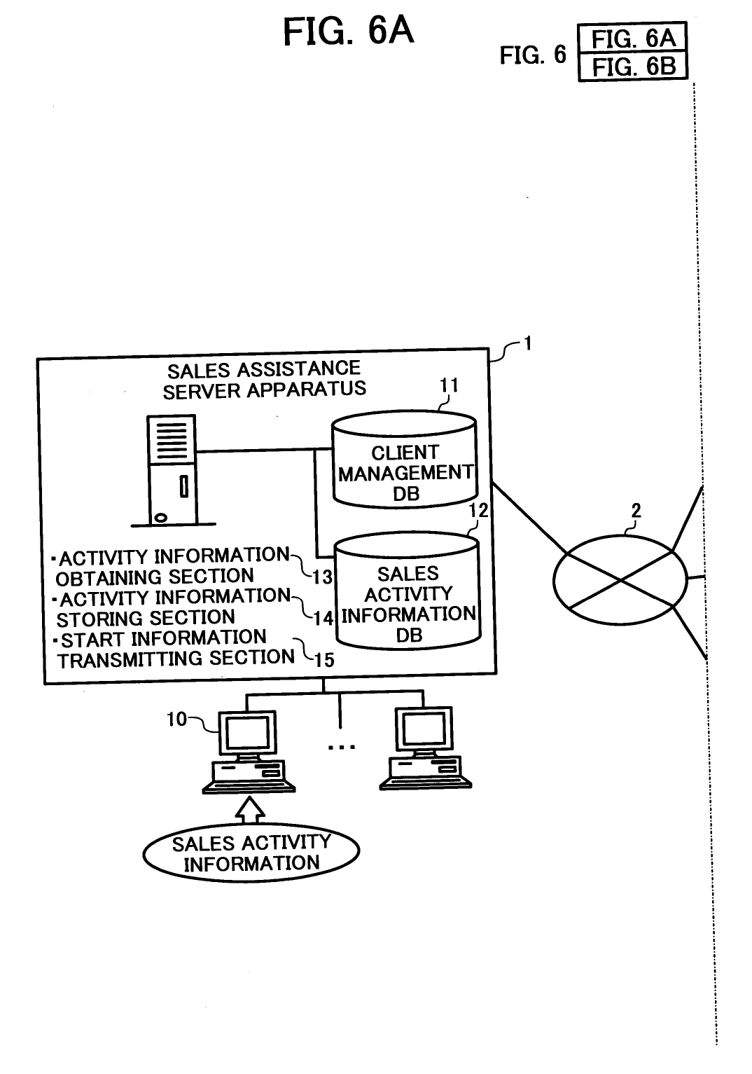

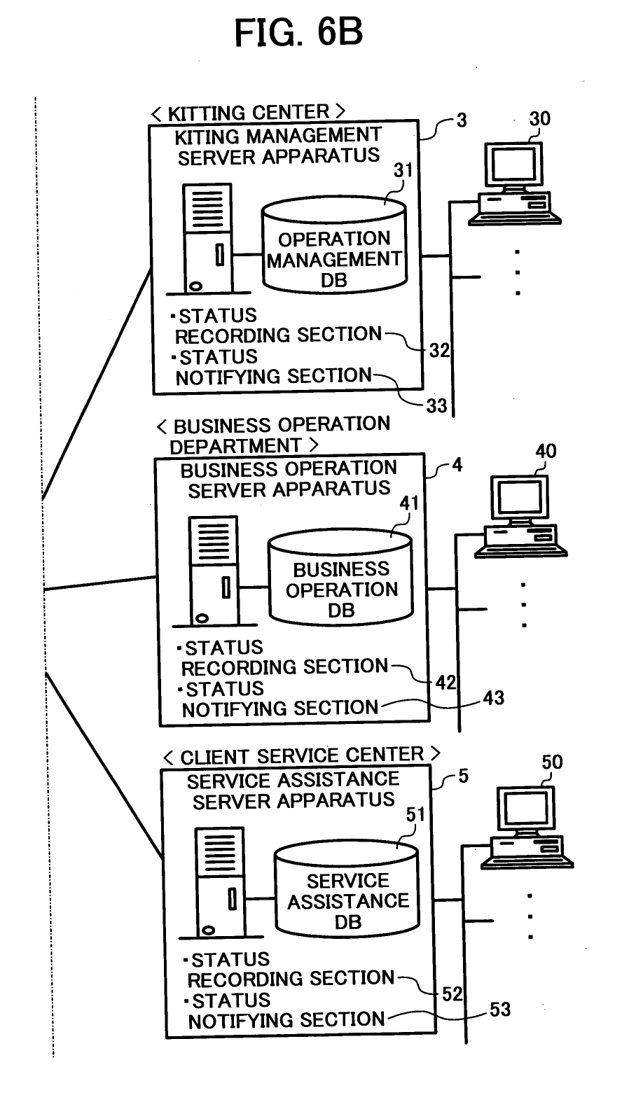

FIG. 6 illustrates one configuration example of a business operation smoothing system according to a third embodiment of the present invention. With reference to FIG. 6, the business operation smoothing system includes the sales assistance server apparatus 1, the kitting management server apparatus 3, the business operation server apparatus 4, and a service assistance server apparatus 5. Since the sales assistance server apparatus 1, the kitting management server apparatus 3 and the business operation server apparatus 4 have the same configuration as that of the business operation smoothing system of FIG. 4, the same reference numerals as those of FIG. 4 are added to the parts corresponding to FIG. 4 and the explanation is omitted.

Herein, the start information transmitting section 15 of the sales assistance server apparatus 1 transmits kitting operation start information relating to the sales activity information to the kitting management server apparatus 3 and transmits business operation start information of the contracted goods to the business operation server apparatus 4, and transmits client service start information of the contracted goods to the service assistance server apparatus 5 based on sales activity information stored by the activity information storing section 14. Moreover, the start information transmitting section 15 transmits the predictive number of sales and the predictive sales date calculated by the predictive sales number calculating section to the kitting management server apparatus 3, the business operation server apparatus 4 and the service assistance server apparatus 5 at the moment when a flag, which shows a status of a matter relating to the sales activity information, is set to, for example, an order status.

The start information transmitting section 15 transmits client service start information of the corresponding goods to the service assistance server apparatus 5 based on sales activity information stored by the activity information storing section 14 at the moment when the flag, which shows a status of a matter relating to goods of a model where an adopter is installed is changed to an order status.

In addition, the sales activity information database 12 of the sales assistance server apparatus 1 is configured to be accessible from the kitting management server apparatus 3, the business operation server apparatus 4, and the service assistance server apparatus 5 via the network (the same network as the network 2 may be possible).

The service assistance server apparatus 5 includes a service assistance database 51, a status recording section 52, a status notifying section 53, and a client master setting section. The service assistance server apparatus 5 is a server apparatus that assists client service at a client service center. Moreover, since the service assistance server apparatus 5 has the same configuration as that of the sales assistance server apparatus 1 shown in FIG. 2, the explanation of the configuration is omitted.

Herein, the client service includes service such as repair, supplies of consumable goods and the like based on the request from the client in addition to the client service based on the report using a client service adapter (adopter that is installed to the client apparatus to grasp the status of equipment via the network).

The client service adapter is a remote diagnostic adapter that is connected (or installed) to the client equipment to grasp the status of equipment via the network (not shown). When the adapter is connected to, for example, a copy machine, the adapter has a function of maintaining a good status of the copy machine by online managing working information such as a change in a value shown by a sensor such as a position sensor, frequency of occurrence of paper jam and the like. Moreover, when trouble occurs, the adapter reports the trouble of equipment to the service assistance server apparatus 5 or the client sends notification of this trouble to the client service center from the copy machine arbitrarily.

A terminal device 50 is a personal computer apparatus that is connected to the service assistance server apparatus 5 via the network.

Information of client service is recorded in the service assistance database S1.

When client service of the goods relating to client service start information is executable at the client service center, the status recording section 52 records information, which indicates that the client service is executable, in the service assistance database 51 based on the client service start information transmitted by the start information transmitting section 15 of the sales assistance server apparatus 1.

The status notifying section 53 sends notification of information, which is recorded by the status recording section 52 and indicates an executable status, to the terminal device 50 of a client service provider. The client service provider can browse the client service start information and start the client service.

The client master setting section adds client information of the goods relating to the client service start information to a client master (database where information of client having equipment to which the adapter is installed) and records the client information therein based on the client service start information transmitted by the start information transmitting section 15 of the sales assistance server apparatus 1.

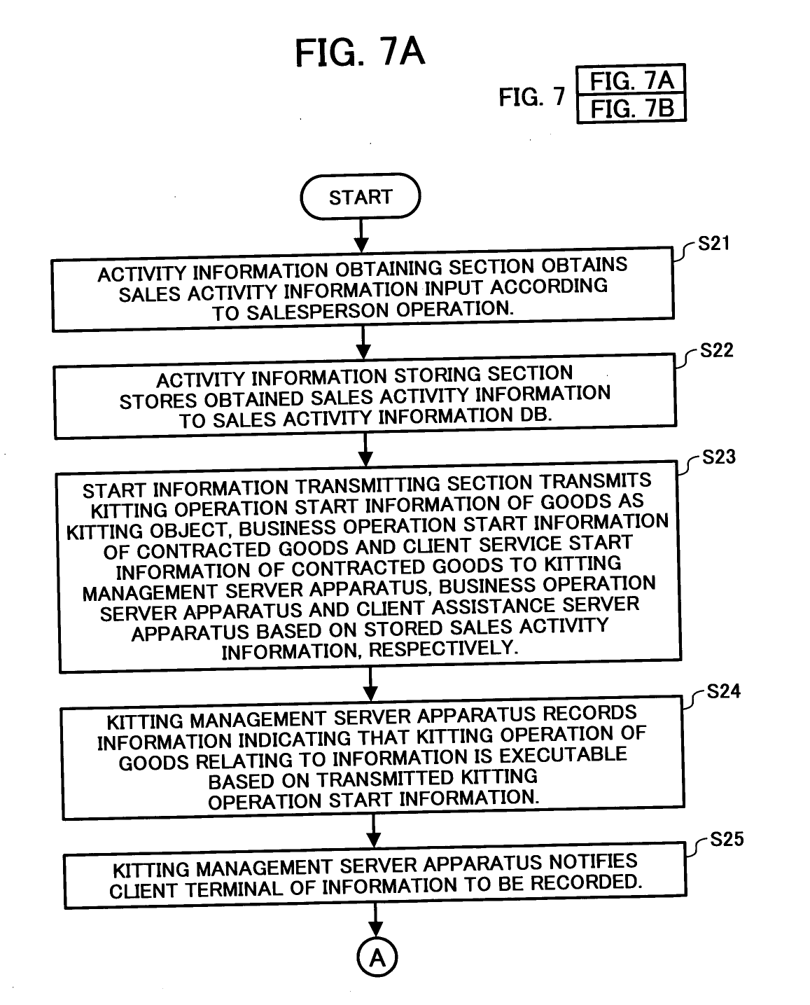

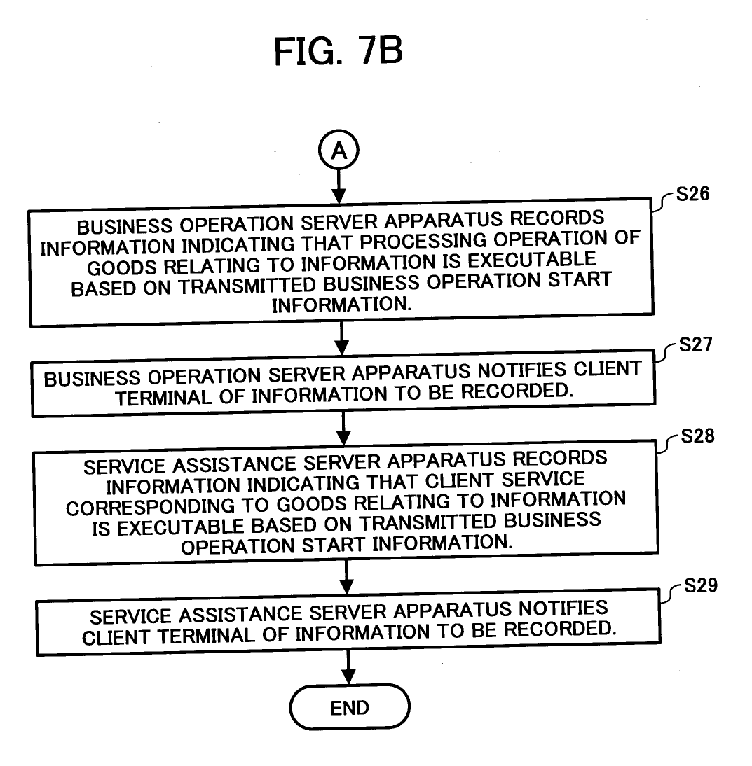

With reference to FIG. 7, the activity information obtaining section 13 of the sales assistance server apparatus 1 obtains sales activity information input from the terminal device 10 according to the salesperson operation (step S21), and transmits the sales activity information to the activity information storing section 14. The activity information storing section 14 stores the received sales activity information to the sales activity information database 12 and records the sales activity information therein (step S22). The start information transmitting section 15 transmits kitting operation start information of the goods as a kitting object, business operation start information of the contracted goods and client service start information of the contracted goods to the kitting management server apparatus 3, the business operation apparatus 4 and the service assistance server apparatus 5, respectively, based on the sales activity information stored by the activity information storing section 14 (step S23). Then, the status recording section 32 of the kitting management server apparatus 3 records information, which indicates that the kitting operation of the goods relating to the kitting start information is executable, in the business operation management database 31 based on the transmitted kitting start information (step S24). The status notifying section 33 of the kitting management server apparatus 3 notifies the terminal apparatus 30 of information that is recorded by the status recording section 32 and indicates an executable status (step S25). The status recording section 42 of the business operation server apparatus 4 records information, which indicates that the processing business operation of the goods relating to the business operation start information is executable, in the business operation management database 41 based on the transmitted business operation start information (step S26). The status notifying section 43 of the business operation server apparatus 4 notifies the terminal apparatus 40 of information that is recorded by the status recording section 42 and indicates an executable status (step S27). The status recording section 52 of the service assistance server apparatus 5 records information, which indicates that the client service corresponding to the goods relating to the client service start information is executable, in the service assistance database 51 based on the transmitted client service start information (step S28). The status notifying section 53 of the service assistance server apparatus 5 sends notification of information, which is recorded by the status recording section 52 and indicates an executable status, to the terminal device 50 (step S29).

As explained above, according to the embodiment of the present invention, it is possible to avoid variations in time and smooth the processing business operations and working such as kitting, delivery and the like that are caused as a result of the sales activity, and improve efficiency of these operations or working. Moreover, since the service assistance server apparatus 5, the business operation server apparatus 4, and the kitting management server apparatus 3 are configured to be accessible to the sales activity information database 12, not only the salesperson but also the client service provider, the business operation processor and the kitting operator share sales activity information. Accordingly, read time of sales activity information to the client service provider, the business operation processor and the kitting operator is reduced, so that efficiency of these operations can be improved.

Furthermore, the start information transmitting section 15 of the sales assistance server apparatus 1 transmits kitting operation start information to the kitting management server 3 and transmits client service start information to the service assistance server apparatus 5. Moreover, the client master setting section of the service assistance server apparatus 5 records client information of the goods relating to the information in the aforementioned client master. Accordingly, information of the client to which the equipment where the adapter is installed is delivered is recoded in the client master until the kitting operation is completed. For this reason, the delivery of equipment and the installation of the adapter can be performed at the same time. On the other hand, in the conventional system, after delivering the equipment, a request was made to the client service center for installation of the adapter via FAX and like. For this reason, the client master was not able to be set before the equipment was delivered, so that the aforementioned operations were not able to be executed at the same time.

(Fourth embodiment)

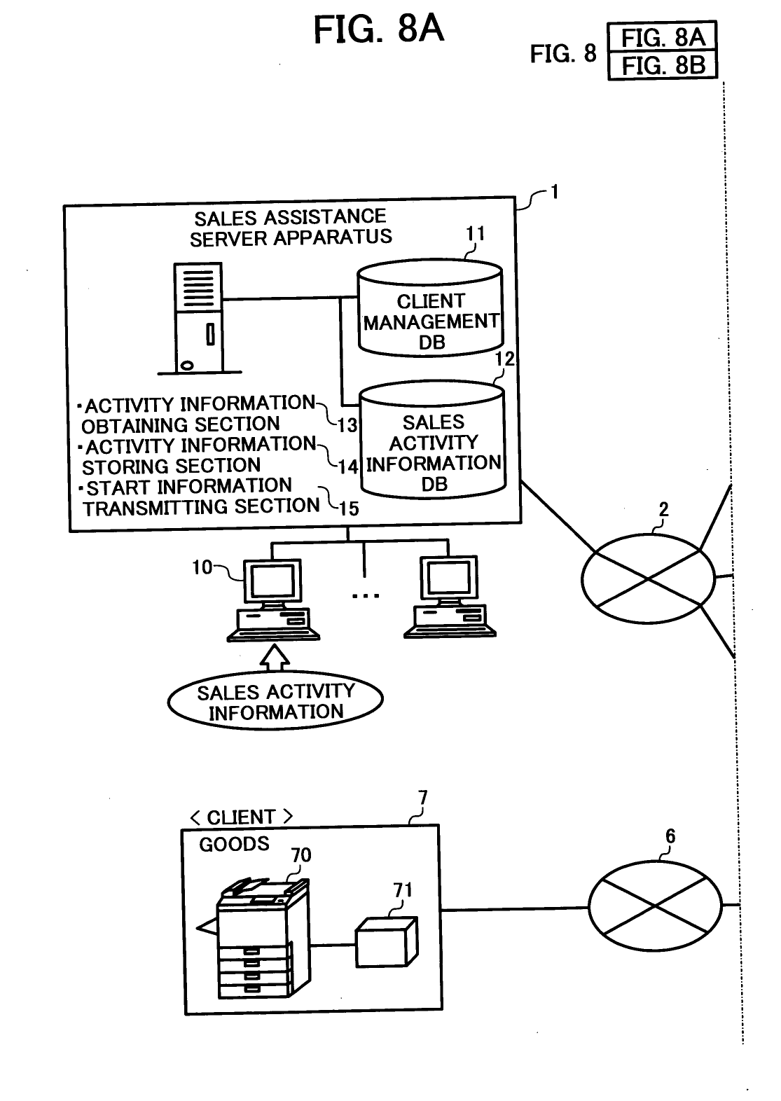

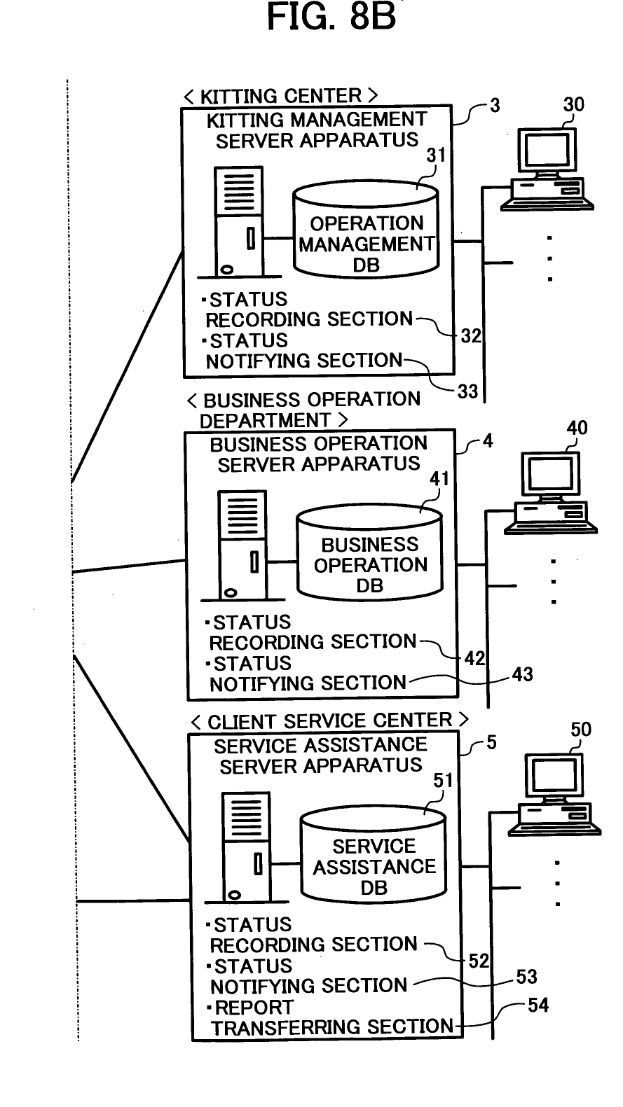

FIG. 8 illustrates one configuration example of a business operation smoothing system according to a fourth embodiment of the present invention. With reference to FIG. 8, the business operation smoothing system includes the sales assistance server apparatus 1, the kitting management server apparatus 3, the business operation server apparatus 4, the service assistance server apparatus 5, and a client apparatus 7. Since the sales assistance server apparatus 1, the kitting management server apparatus 3 and the business operation server apparatus 4 have the same configuration as that of the business operation smoothing system of FIG. 6, the same reference numerals as those of FIG. 6 are added to the parts corresponding to FIG. 6 and the explanation is omitted.

Herein, similar to the third embodiment, the start information transmitting section 15 of the sales assistance server apparatus 1 transmits kitting operation start information, business operation start information of contracted goods and client service start information of the contracted goods to the kitting management server apparatus 3, the business operation server apparatus 4 and the service assistance server apparatus 5, respectively.

The activity information obtaining section 13 transmits information transferred from a report transferring section 54 of the service assistance server apparatus 5 to be described later to the activity information storing section 14. The activity information storing section 14 stores this information as sales activity information to the sales activity information database 12. The start information transmitting section 15 transmits client service start information of goods of a model where an adopter is installed to the service assistance server apparatus 5 at the moment when a flag, which shows a status of a matter relating to the sales activity information, is set to, for example, an order status.

In addition, similar to the third embodiment, the sales activity information databases 12 of the sales assistance server apparatus 1 is configured to be accessible from the kitting management server apparatus 3, the business operation server apparatus 4 and the service assistance server apparatus 5.

The service assistance server apparatus 5 includes a service assistance database 51, a status recording section 52, a status notifying section 53, and a report transferring section 54. Moreover, since the service assistance server apparatus 5 of this embodiment has the same configuration as that of the service assistance server apparatus 5 shown in FIG. 6 except the report transferring section 54, the same reference numerals as those of FIG. 6 are added to the same configuration parts of FIG. 6 and the explanation is omitted.

The report transferring section 54 transfers a report from the client apparatus 7 and information transmitted according to the report to the sales assistance server apparatus 1. The sales assistance server apparatus 1 stores the transferred information as sales activity information.

The client apparatus 7 includes a copy machine 70 and a client service adapter 71. The client apparatus 7 is connected to the service assistance server apparatus 5 via the network 6.

The copy machine 70 is a multi function printer. In addition, the copy machine 70 may be other OA equipment.

The client service adapter 71 is an adapter that is connected (installed) to the copy machine 70 and grasps the status of the copy machine 70 at the client service center.

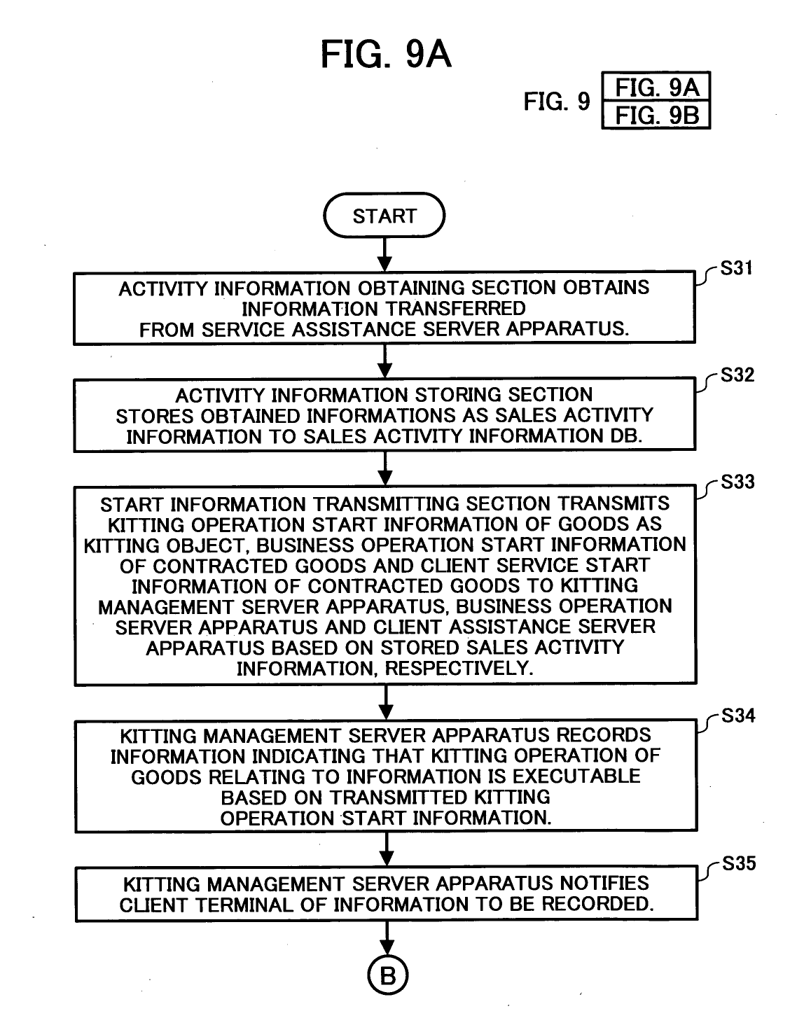

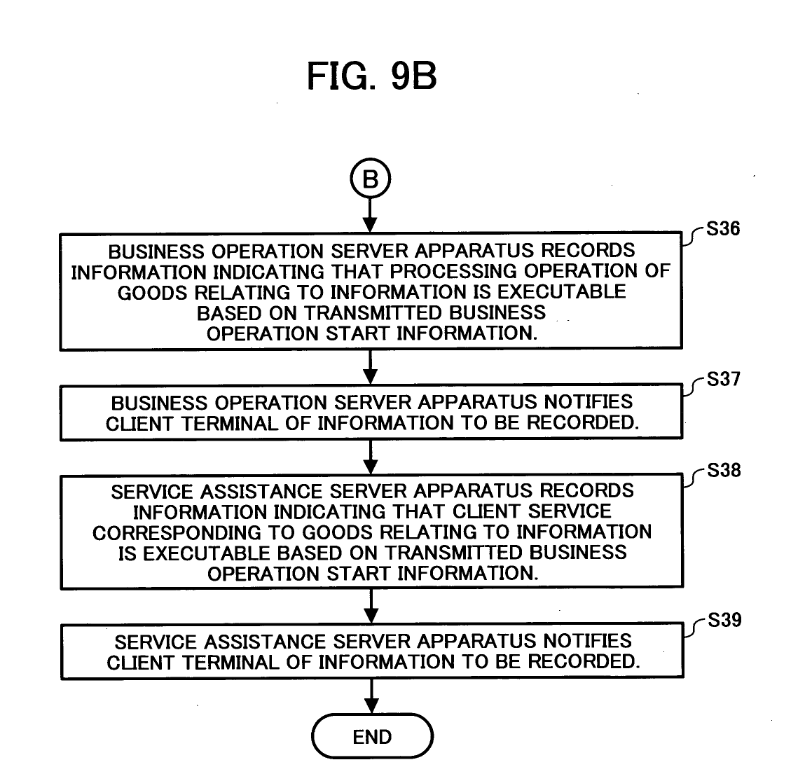

With reference to FIG. 9, the activity information obtaining section 15 of the sales assistance server apparatus 1 obtains information transferred from the service assistance server apparatus 5 (step S31), and transmits the information to the activity information storing section 14. The activity information storing section 14 stores the received sales activity information as sales activity information (step S32). Steps S33 to S39 explained below are the same as steps S23 to S29 of the third embodiment. The sales assistance server apparatus 1 transmits kitting operation start information of the goods as a kitting object, business operation start information of the contracted goods and client service start information corresponding to the contracted goods to the kitting management server apparatus 3, the business operation apparatus 4 and the service assistance server apparatus 5, respectively (step S33). The kitting management server apparatus 3 records information which indicates that the kitting operation of the goods relating to the transmitted kitting operation start information is executable (step S34). The kitting management server apparatus 3 notifies the terminal apparatus 30 of information indicating an executable status (step S35). The business operation server apparatus 4 records information, which indicates that the processing business operation of the goods relating to the transmitted business operation start information is executable (step S36). The business operation server apparatus 4 notifies the terminal apparatus 40 of information, which indicates an executable status (step S37). The service assistance server apparatus 5 records information, which indicates that the client service corresponding to the goods relating to the transmitted client server start information is executable status (step S38). The service assistance server apparatus 5 sends notification of information, which indicates an executable status, to the terminal device 50 (step S39).

As explained above, according to the embodiment of the present invention, information transmitted according to the report from the adapter connected to the client equipment is used as sales activity information. Then, it is possible to avoid variations in time, and to smooth the client support, the processing business operations which are carried out by the business operation department, working such as kitting, and delivery and the like that occur according to this information, so as to improve efficiency of these operations and working. Moreover, since the service assistance server apparatus 5, the business operation server apparatus 4, and the kitting management server apparatus 3 are configured to be accessible to the sales activity information database 12, not only the salesperson but also the client service provider, the business operation processor, and the kitting operator share sales activity information. Accordingly, read time of sales activity information to the client service provider, the business operation processor and the kitting operator is reduced, so that efficiency of these operations can be improved.

In the aforementioned embodiment, it is preferable that the client service adapter 71 be lent from the client service center. The adapter 71 may be combined with the copy machine 70 and sold, or installed according to the client's request after selling the equipment. In this case, it is desirable that the business operation server apparatus notify the terminal apparatus 40 of information, which indicates that the adapter order processing is executable with the goods order processing.

The above embodiment has explained that the sales assistance server apparatus 1, the kitting management server apparatus 3, the business operation server apparatus 4, the service assistance server apparatus 5, the terminal apparatuses 10, 30, 40, 50 and various kinds of databases are installed in the company to which the user belongs. However, the entirety or some of these components may be installed to an application service provider (ASP). Moreover, though the various databases have been explained as a specific form in which they are physically included in the server apparatus, such a specific form that these databases may be connected to the server apparatus via the network to be placed in a physically discrete manner. Furthermore, though the various databases have been explained as those having a different configuration, these databases may be configured as one database if the configuration that can achieve the function of each database is provided.

Though the above embodiment has not particularly explained dedicated software (DB management system) that maintains and operates DB, it is preferable that the dedicated software be provided to the sales assistance server apparatus 1, the kitting management server apparatus. 3, the business operation server apparatus 4 and the service assistance server apparatus 5. Accordingly, data in DB is made physically and logically independent of the program (application software) of the present invention that causes the computer to execute the aforementioned sections, making it easy to update versions of various application software and construct the system. Moreover, this makes it easy to maintain consistency of data in DB and ensure security of data. Furthermore, each server apparatus may have a hierarchical structure and execute processing to correspond to the hierarchical structure.

The above embodiment has explained that the terminal devices 30, 40, and 50 are connected to the kitting management server apparatus 3, the business operation server 4, and the service assistance server apparatus S via the network, respectively. However, regarding the start information of various kinds, the kitting management server apparatus 3, the business operation server apparatus 4 and the service assistance server apparatus 5 may singly provide the kitting operation, the processing business operation and the client service, respectively.

The program that causes each server apparatus of the business operation smoothing system according to the aforementioned embodiments to execute the aforementioned sections may be stored on a recording medium such as CD-ROM, an optical magnetic disk, DVD-ROM, FD and the like and distributed. Furthermore, the program may be stored on a flash memory and ROM or RAM of various types. Moreover, the program may be supplied to each server apparatus via the Internet. Still moreover, the program provided by ASP may be executed by each server apparatus.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-135845 filed on May 14, 2003 and including specification, claims, drawings and summary. The disclosure of the above Japanese Patent Application is incorporated herein by reference in its entirety.

What is claimed is:

1. A business operation smoothing system comprising:
a sales assistance server apparatus that performs sales assistance for a salesperson of goods; and
a kitting management server apparatus that is connected to said sales assistance server apparatus via a network to manage a kitting operation at a kitting center that executes kitting of goods,
wherein said sales assistance server apparatus includes:
an activity information obtaining section that obtains sales activity information input according to a user operation;
an activity information storing section that stores the sales activity information obtained by said activity information obtaining section; and
a start information transmitting section that transmits kitting operation start information for starting the kitting operation to said kitting management server apparatus based on the sales activity information stored in said activity information storing section.

2. The business operation smoothing system according to claim 1, wherein said kitting management server apparatus includes a status recording section that records information indicating that the kitting operation of goods relating to the kitting operation start information is executable based on the kitting operation start information transmitted from said start information transmitting section.

3. The business operation smoothing system according to claim 2, wherein said kitting management server apparatus notifies a client terminal apparatus of the information that is recorded by said status recording section.

4. The business operation smoothing system according to claim 1,
wherein said sales assistance server apparatus stores information of a success rate in each stage of the sales activity to be associated with the sales activity information; and
wherein said start information transmitting section includes a sales predicting section that calculates the predictive number of selling goods and a predictive sales date thereof based on the sales activity information stored in said activity information storing section and the success rate and transmits the predictive number of selling goods and/or predictive sales date calculated by said sales predicting section.

5. The business operation smoothing system according to claim 4, wherein said kitting management server apparatus further includes a schedule calculating section that calculates a schedule including a personnel assignment and operation contents in connection with the kitting operation based on the kitting operation start information.

6. The business operation smoothing system according to claim 1, further comprising a service assistance server apparatus that is connected to said sales assistance server apparatus via the network to assist client service at the client service center,
wherein said start information transmitting section transmits client service start information for starting to provide client service to a client relating to the sales activity information to said service assistance server apparatus based on the sales activity information stored in said activity information storing section.

7. The business operation smoothing system according to claim 6, wherein said service assistance server apparatus includes a status recording section that records information indicating that client service of goods relating to the client service start information is executable based on the client service start information transmitted from said start information transmitting section.

8. The business operation smoothing system according to claim 7, wherein said service assistance server apparatus notifies a client terminal apparatus of the information that is recorded by said status recording section.

9. The business operation smoothing system according to claim 6,
wherein said sales assistance server apparatus stores information of a success rate in each stage of the sales activity to be associated with the sales activity information; and
wherein said start information transmitting section includes a predictive sales number calculating section that calculates the predictive number of selling goods relating to the sales activity information and a predictive sales date thereof based on the sales activity information stored in said activity information storing section and the success rate and transmits the predictive number of selling goods and/or predictive sales date calculated by said predictive sales number calculating section.

10. The business operation smoothing system according to claim 6, wherein said service assistance server apparatus further includes a report transferring section that is connected to a client service adapter connected to client equipment via a network to transfer a report from the client service adapter and information transmitted according to the report to said sales assistance server apparatus.

11. The business operation smoothing system according to claim 1, further comprising a business operation server apparatus that is connected to said sales assistance server apparatus via the network to manage a business operation of a company to which the salesperson belongs,
wherein said start information transmitting section further includes a section that transmits business operation start information for starting business operation processing of the goods relating to the sales activity information to said business operation server apparatus based on the sales activity information stored in said activity information storing section.

12. The business operation smoothing system according to claim 11, wherein said business operation server apparatus includes a status recording section that records information indicating that any one of order processing, delivery processing and sales processing or multiple processing of the goods relating to the business operation start information is executable based on the business operation start information transmitted from said start information transmitting section.

13. The business operation smoothing system according to claim 12, wherein said business operation server apparatus notifies a client terminal apparatus of the information that is recorded by said status recording section.

14. The business operation smoothing system according to claim 11,
wherein said sales assistance server apparatus stores information of a success rate in each stage of the sales activity to be associated with the sales activity information; and
wherein said start information transmitting section includes a predictive sales number calculating section that calculates the predictive number of selling goods relating to the sales activity information and a predictive sales date thereof based on the sales activity information stored in said activity information storing section and the success rate and transmits the predictive number of selling goods and/or predictive sales date calculated by said predictive sales number calculating section.

15. A business operation smoothing system comprising:
a sales assistance server apparatus that performs sales assistance for a salesperson of goods; and
a service assistance server apparatus that is connected to said sales assistance server apparatus via a network to assist client service at a client service center,
wherein said sales assistance server apparatus includes:
an activity information obtaining section that obtains sales activity information input according to a user operation;
an activity information storing section that stores the sales activity information obtained by said activity information obtaining section; and
a start information transmitting section that transmits client service start information for starting to provide client service to the service assistance server apparatus based on the sales activity information stored in said activity information storing section.

16. The business operation smoothing system according to claim 15, wherein said service assistance server apparatus further includes a report transferring section that is connected to a client service adapter connected to client equipment via a network to transfer a report from the client service adapter and information transmitted according to the report to said sales assistance server apparatus.

17. A business operation smoothing system comprising:
a sales assistance server apparatus that performs sales assistance for a salesperson of goods; and
a business operation server apparatus that is connected to said sales assistance server apparatus via a network to manage a business operation of a company to which the salesperson belongs,
wherein said sales assistance server apparatus includes:
an activity information obtaining section that obtains sales activity information input according to a user operation;
an activity information storing section that stores the sales activity information obtained by said activity information obtaining section; and
a start information transmitting section that transmits business operation start information for starting business operation processing to the business operation server apparatus based on the sales activity information stored in said activity information storing section.

18. The business operation smoothing system according to claim 1, wherein said activity information obtaining section obtains sales activity information input from a client terminal apparatus via the network.

19. A business operation smoothing system comprising a sales assistance server apparatus that performs sales assistance for a salesperson of goods and at least one server apparatus of a kitting management server apparatus that is connected to said sales assistance server apparatus via a network to manage a kitting operation at a kitting center that executes kitting of goods, a business operation server apparatus that manages a business operation of a company to which the salesperson belongs and a service assistance server apparatus that assists client service,
wherein said sales assistance server apparatus includes:
an activity information obtaining section that obtains sales activity information input according to a user operation;
an activity information storing section that stores the sales activity information obtained by said activity information obtaining section; and
a start information transmitting section that transmits start information for starting business operation processing of the goods relating to the sales activity information to said server apparatus based on the sales activity information stored in said activity information storing section.

20. A business operation smoothing method using:
a sales assistance server apparatus that performs sales assistance for a salesperson of goods; and
a kitting management server apparatus that is connected to said sales assistance server apparatus via a network to manage a kitting operation at a kitting center that executes kitting of goods, said method comprising:
the activity information obtaining step of causing said sales assistance server apparatus to obtain sales activity information input according to a user operation;
the activity information storing step of storing sales activity information of the salesperson obtained by said activity information obtaining step in said sales assistance server apparatus; and
the start information transmitting step of causing said sales assistance server apparatus to transmit kitting operation start information of the goods as a kitting object to said kitting management server apparatus based on the sales activity information stored by said activity information storing step.

21. The business operation smoothing method according to claim 20, wherein said start information transmitting step includes the step of causing said sales assistance server apparatus to transmit client service start information corresponding to the goods relating to the sales activity information to a service assistance server apparatus that is connected to said sales assistance server apparatus via the network to assist client service at a client service center based on the sales activity information stored by said activity information storing step.

22. The business operation smoothing method according to claim 20, wherein said start information transmitting step includes the step of causing said sales assistance server apparatus to transmit business operation start information of the goods relating to the sales activity information to a business operation server apparatus that is connected to said sales assistance server apparatus via the network to manage a business operation of a company to which the salesperson belongs based on the sales activity information stored by said activity information storing step.

23. A business operation smoothing method using:
a sales assistance server apparatus that performs sales assistance for a salesperson of goods; and
a service assistance server apparatus that is connected to said sales assistance server apparatus via a network to assist client service at a client service center,
said method comprising:
the activity information obtaining step of causing said sales assistance server apparatus to obtain sales activity information input according to a user operation;
the activity information storing step of storing sales activity information of the salesperson obtained by said activity information obtaining step in said sales assistance server apparatus; and
the start information transmitting step of causing said sales assistance server apparatus to transmit client service start information of the client of the goods relating to the sales activity information to said service assistance server apparatus based on the sales activity information stored by said activity information storing step.

24. A business operation smoothing method using:
a sales assistance server apparatus that performs sales assistance for a salesperson of goods; and
a business operation server apparatus that is connected to said sales assistance server apparatus via a network to manage a business operation of a company to which the salesperson belongs,
said method comprising:
the activity information obtaining step of causing said sales assistance server apparatus to obtain sales activity information input according to a user operation;
the activity information storing step of storing sales activity information of the salesperson obtained by said activity information obtaining step in said sales assistance server apparatus; and
the start information transmitting step of causing said sales assistance server apparatus to transmit business operation start information of a processing business operation of the goods relating to the sales activity information to said business operation server apparatus based on the sales activity information stored by said activity information storing step.

25. A business operation smoothing method using a sales assistance server apparatus that performs sales assistance for a salesperson of goods and at least one server apparatus of a kitting management server apparatus that is connected to said sales assistance server apparatus via a network to manage a kitting operation at a kitting center that executes kitting of goods, a business operation server apparatus that manages a business operation of a company to which the salesperson belongs and a service assistance server apparatus that assists client service,
said method comprising:
the activity information obtaining step of causing said sales assistance server apparatus to obtain sales activity information input according to a user operation;
the activity information storing step of storing sales activity information of the salesperson obtained by said activity information obtaining step in said sales assistance server apparatus; and
the start information transmitting step of causing said sales assistance server apparatus to transmit start information for starting processing of the goods relating to the sales activity information to said server apparatus based on the sales activity information stored by said activity information storing step.

26. The business operation smoothing method according to claim 25, further comprising:
the step of storing information of a success rate in each stage of the sales activity to be associated with the sales activity information;
the step of calculating the predictive number of selling goods relating to the sales activity information and a predictive sales date thereof based on the sales activity information stored by said activity information storing step and the success rate; and
the step of transmitting the predictive number of selling goods and/or predictive sales date calculated by said predictive sales number calculating step to said server apparatus.

27. A program product including a program functioning as a business operation smoothing system by causing a computer to execute to operate the whole or part of:
an activity information obtaining section that obtains sales activity information input according to a user operation;
an activity information storing section that stores the sales activity information obtained by said activity information obtaining section; and
a start information transmitting section that transmits kitting operation start information of goods as a kitting object to a kitting management server apparatus that is connected to said computer via a network to manage a kitting operation at a kitting center that executes kitting of goods based on the sales activity information stored in said activity information storing section.

28. A program product including a program functioning as a business operation smoothing method by causing a computer to execute:
the activity information obtaining step of obtaining sales activity information input according to a user operation;
the activity information storing step of storing sales activity information of the salesperson obtained by said activity information obtaining step in a sales assistance server apparatus; and
the start information transmitting step of transmitting kitting operation start information of goods as a kitting object to a kitting management server apparatus that is connected to said computer via a network to manage a kitting operation at a kitting center that executes kitting of goods based on the sales activity information stored by said activity information storing step.
